(19) United States
(12) Patent Application Publication
(10) Pub. No.: US 2007/0038322 A1
(43) Pub. Date: Feb. 15, 2007

(54) Designing assisting apparatus, designing assisting method, and program

(76) Inventors: Yoshinori Iizuka, Tokyo (JP); Yasuhiko Tamura, Tokyo (JP); Takaki Tokuyama, Tokushima (JP); Takeshi Ozaki, Tokushima (JP)

Correspondence Address: SUGHRUE MION, PLLC, 2100 PENNSYLVANIA AVENUE, N.W., SUITE 800, WASHINGTON, DC, 20037, US

(21) Appl. No.: 10/548,376

(22) PCT Filed: Mar. 3, 2004
(86) PCT No.: PCT/JP04/02612

§ 371 Date: Aug. 14, 2006

(30) Foreign Application Priority Data
Mar. 7, 2003 (JP) 2003-61677

(51) Int. Cl. G06F 19/00

(52) U.S. Cl. 700/97

(57) ABSTRACT

In a designing assisting apparatus 901, a memory section 902 stores trouble records of a design target, a dictionary section 903 stores related records, an input accepting section 904 accepts the input of a definition attribute name, a control attribute name or a stress attribute name, a search section 905 searches for that trouble record which includes the definition attribute name, etc., searches for that related record which includes the trouble mode name included in the searched trouble record, as a cause name, searches for that trouble record which includes the definition attribute name, control attribute name, stress attribute name, strength name or trouble mode name included as a result name in the searched related record, and repeats them until no new trouble record is searched, and a display section 906 displays the searched trouble record, and displays an arrow associated with the searched related record between the trouble records.

### TECHNICAL FIELD

The invention relates to a designing assisting apparatus, a designing assisting method, and a program realized at a computer.

### BACKGROUND ART

Conventionally, there has been proposed a designing assisting technique using a computer like CAD/CAM (Computer Aided Design/Computer Aided Manufacturing) system. In designing various apparatuses, etc., which comprise multiple parts, it is necessary to sufficiently pay attention to whether or not various parts and an apparatus which has those parts connected together satisfy requirements. In such an aspect, the assistance by a computer is desired.

Meanwhile, it is difficult for a man to easily know, at the designing stage, whether or not a trouble occurs if a design target is actually made into a prototype or is manufactured, and, acquisition of such knowledge requires a long years of experience and hutches.

However, today when a design target is diversified and is complex, there is a demand for a designing assist environment which does not rely on the experiences and hutches of engineers, but uses a computer that shares them as “knowledge”, and uses the knowledge at the designing stage, is desired.

The present invention solves the above-described problem, and aims at providing a designing assisting apparatus and a designing assisting method, which are suitable for finding the possibility that a trouble or the like will occur in a design target at the designing stage, and a program allowing the computer to realize them.

### DISCLOSURE OF INVENTION

To achieve the aforementioned object, the following invention will be disclosed based on the principal of the present invention.

A designing assisting apparatus according to the first aspect of the invention comprises a memory section, a dictionary section, an input accepting section, a search section and a display section, and is constructed as follows.

That is, the memory section stores trouble records which associate one definition attribute name or more, zero control attribute name or more, zero stress attribute name or more, and zero strength name or more of a design target with one trouble mode name or more.

Meanwhile, the dictionary section stores related records which associate a trouble mode name as a cause name with a definition attribute name, a control attribute name, a stress attribute name, a strength name or a trouble mode name as a result name.

Further, the input accepting section accepts one or more inputs of the definition attribute name, the control attribute name or the stress attribute name.

The search section

(a) searches the stored trouble records for a trouble record which includes the definition attribute name, control attribute name or stress attribute name whose input has been accepted,

(b) searches the stored related records for a related record which includes the trouble mode name included in the searched trouble record, as a cause name,

(c) searches the stored trouble records for a trouble record which includes the definition attribute name, control attribute name, stress attribute name, strength name or trouble mode name included as a result name in the searched related record, and

(d) repeats the (b) and (c) until no new trouble record is searched.

Meanwhile, the display section

(p) displays the searched trouble record, and

(q) further displays a figure connecting the displayed trouble record and the displayed another trouble record when a related record including a trouble mode name in the displayed trouble record as a cause name, and a definition attribute name, a control attribute name, a stress attribute name, a strength name or a trouble mode names as a result name in the displayed another trouble record is stored in the dictionary section.

In the designing assisting apparatus of the invention, the display section can be constructed in such a way as to farther display the cause name in association with that trouble record which includes the cause name, further display the result name in association with that trouble record which includes the result name, and display “a reference figure (including a figure of an arrow) from the cause name to the result name” as “a figure connecting the displayed trouble record and the displayed another trouble record”.

In the designing assisting apparatus of the invention, the dictionary section can be constructed in such a way as to store a simultaneous related record which associates a plurality of trouble mode names as simultaneous cause names with a definition attribute name, a control attribute name, a stress attribute name or a trouble mode name as a simultaneous result name, and the display section can be constructed in such a way as to highlight the reference figure when, in the “reference figure from the cause name to the result name”, “the stored plurality of trouble mode names as the simultaneous cause names of ‘the simultaneous related record to be stored in the memory section with the result name as the simultaneous result name’ are all displayed by the display section.

In the designing assisting apparatus of the invention, the search section can be constructed in such a way as to

(a′) search the stored trouble records for a trouble record which includes the definition attribute name, control attribute name or stress attribute name whose input has been accepted and which includes at least one of the definition attribute names whose inputs have been accepted, in place of said (a).

A designing assisting method according to another aspect of the invention uses a memory section which stores trouble records associating one definition attribute name or more, zero control attribute name or more, zero stress attribute name or more, and zero strength name or more of a design target with one trouble mode name or more, and a dictionary section which stores related records associating a trouble mode name as a cause name with a definition attribute name, a control attribute name, a stress attribute name, a strength name or a trouble mode name as a result name, and comprises an input accepting step, a search stop and a display step, and is constructed as follows.

That is, at the input accepting step, one or more inputs of the definition attribute name, the control attribute name or the stress attribute name are accepted.

Meanwhile, at the search section,

(a) the stored trouble records are searched for a trouble record which includes the definition attribute name, control attribute name or stress attribute name whose input has been accepted,

(b) the stored related records are searched for a related record which includes the trouble mode name included in the searched trouble record, as a cause name,

(c) the stored trouble records are searched for a trouble record which includes the definition attribute name, control attribute name, stress attribute name, strength name or trouble mode name included as a result name in the searched related record, and

(d) the (b) and (c) are repeated until no new trouble record is searched.

Further, at the display section,

(p) the searched trouble record is displayed, and

(q) a figure connecting the displayed trouble record and the displayed another trouble record is further displayed when a related record including a trouble mode name in the displayed trouble record as a cause name, and a definition attribute name, a control attribute name, a stress attribute name, a strength name or a trouble mode name as a result name in the displayed another trouble record is stored in the dictionary section.

A program according to another aspect of the invention is structured in such a way as to allow a computer to function as the designing assisting apparatus, or allow a computer to execute the designing assisting method.

The program can be recorded on various recording media, such as CD-ROM (Compact Disk Read Only Memory) and FD (Flexible Disk), and can be distributed over a computer communication network, such as the Internet.

### BRIEF DESCRIPTION OF DRAWINGS

FIG. 1 is an exemplary diagram illustrating the brief structure of an information processing apparatus.

FIG. 2 is a pattern diagram illustrating the basic structure of a designing assisting apparatus according to one embodiment of the present invention.

FIG. 3 is an exemplary diagram illustrating the brief structures of the data structures of information stored in a definition-attribute dictionary section and the control-attribute dictionary section.

FIG. 4 is an exemplary diagram illustrating the brief structure of the data structure of information stored in a strength dictionary section.

FIG. 5 is an exemplary diagram illustrating the brief structure of the data structure of information stored in a stress dictionary section.

FIG. 6 is an exemplary diagram illustrating the brief structure of the data structure of information stored in a comparison-report dictionary section.

FIG. 7 is a flowchart illustrating the procedures of a designing assisting process.

FIG. 8 illustrates the brief structure of that portion which is stored in the control-attribute dictionary section.

FIG. 9 is an exemplary diagram illustrating the brief structure of a designing assisting apparatus according to one embodiment of the invention.

FIG. 10 is a flowchart illustrating the control flow of a process which is executed by the designing assisting apparatus.

FIG. 11 is an explanatory diagram illustrating one appearance of a trouble record.

FIG. 12 is an explanatory diagram illustrating the appearance of information stored in the dictionary section.

FIG. 13 is an explanatory diagram illustrating a form for receiving an input of the name of a configuration item.

FIG. 14 is an explanatory diagram illustrating a from showing a definition attribute name, a control attribute name, or a stress attribute name obtained by term expansion.

FIG. 15 is an explanatory diagram illustrating searched trouble records.

FIG. 16 is an explanatory diagram illustrating a form showing the relationship between the searched trouble records and their chains.

FIG. 17 is an explanatory diagram illustrating a form showing the relationship between the searched trouble records and their chains.

FIG. 18 is an explanatory diagram illustrating a form showing the relationship between the searched trouble records and their chains.

FIG. 19 is an explanatory diagram illustrating a form showing the relationship between the searched trouble records and their chains.

### BEST MODE FOR CARRYING OUT THE INVENTION

An embodiment of the present invention will now be explained with reference to the accompanying drawings.

(Brief Structure of Information Processing Apparatus)

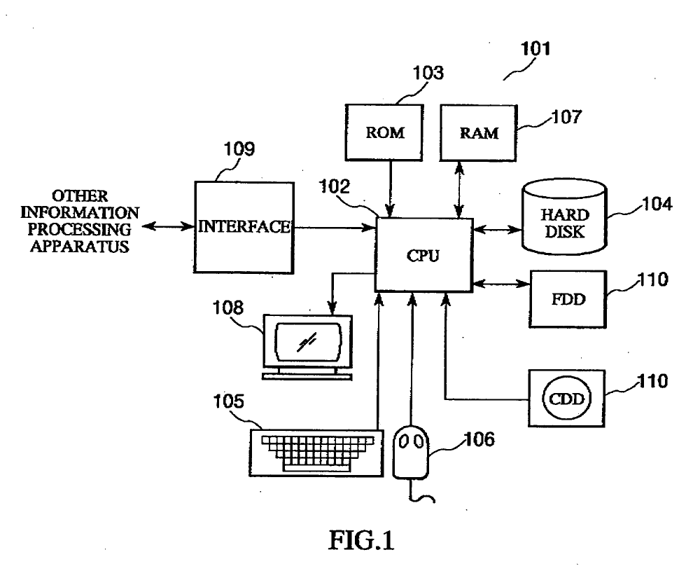

There is an exemplary diagram illustrating the brief structure of a typical information processing apparatus which can process a recording medium having a data structure stored therein, and function as a designing assisting apparatus of the invention. Explanations will be given below with reference to FIG. 1.

An information processing apparatus 101 is controlled by a CPU (Central Processing Unit) 102. When power is applied to the information processing apparatus 101, the CPU 102 executes an IPL (Initial Program Loader; initial program loader) which is stored in a ROM 103.

The IPL is a program which reads out and executes an OS (Operating System) program stored in a recording medium, such as a hard disk 104, an FD mounted in an FD drive 110, or a CD-ROM mounted in a CD-ROM drive 111.

After the OS is started up, the CPU 102 executes an application program stored in the hard disk, etc., in accordance with a user's instruction input through a key board 105 and a mouse 106 or the like, or in accordance with the contents of a configuration file pre-described in the hard disk or the like.

Executing the application program, the information processing apparatus 101 functions as the designing assisting apparatus.

Definition attributes, control attributes, strength information, stress information, and trouble records are recorded in the recording medium, such as the hard disk 104, the FD mounted in the FD drive 110, or the CD-ROM mounted in the CD-ROM drive 111.

The CPU 102 uses a RAM 107 as the temporary work memory area at the time of executing the program In addition, as the temporary work memory area, a register and a cache (both not illustrated) provided in the CPU 11 are used.

Along with the execution of the program, to report a trouble record and to show the progress, the CPU 102 can display that information on a display apparatus 108, such as a liquid crystal display or a CRT (Cathode Ray Tube). Regarding the instructional operation with the mouse 106, moving the mouse 106 moves the cursor displayed on the screen, and a menu item indicated by the cursor can be selected by clicking the mouse 106.

The information processing apparatus 101 can communicate with a computer communication network like the Internet through an interface 109, such as an NIC (Network Interface Card) or a modem. It can process information on a design target, received via the interface 109, send a processed trouble record via the interface 109, execute the program received via the interface 109, and so on.

It is possible to use a mode where the user is presented with various trouble records are put in another computer, a URL (Universal Resource Locator) of the trouble record and a summary thereof, and the user obtains the details of the trouble record from the URL via the interface 109, when needed.

(Basic Structure of Designing Assisting Apparatus)

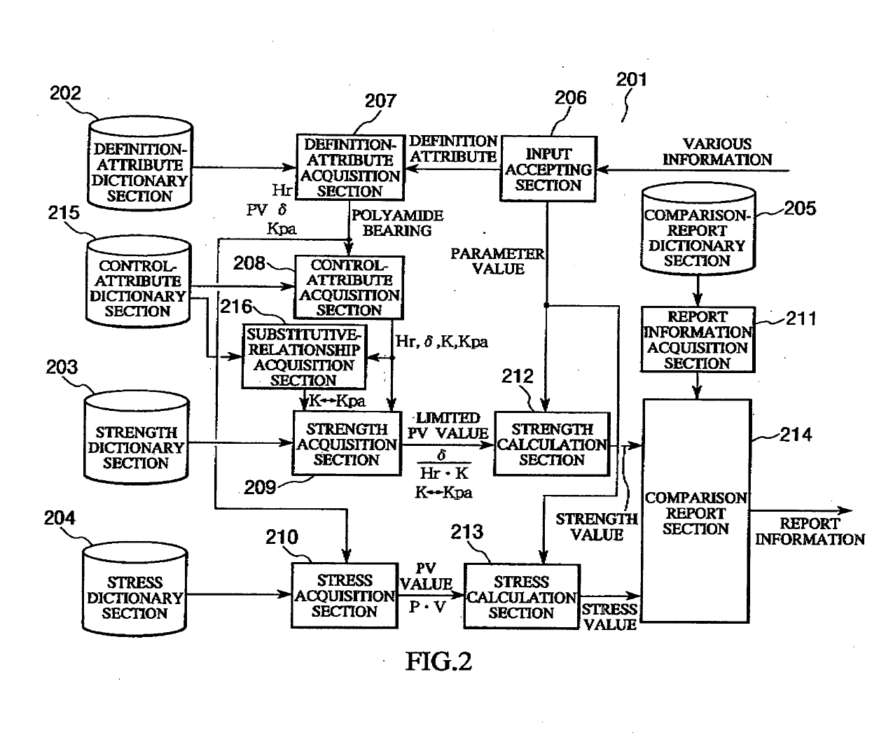

FIG. 2 is an exemplary diagram illustrating the basic structure of the design assisting apparatus used in one embodiment of the invention. A description will be given below with reference to the diagram. Explanation will be given of a case, as an example, where a polyamide bearing is designed.

A design assisting apparatus 201 includes a definition-attribute dictionary section 202, a strength dictionary section 203, a stress dictionary section 204, a comparison-report dictionary section 205, an input accepting section 206, definition-attribute acquisition section 207, a control-attribute acquisition section 208, a strength acquisition section 209, a stress acquisition section 210, a report-information acquisition section 211, a strength calculation section 212, a stress calculation section 213, a comparison report section 214, a control-attribute dictionary section 215, and a substitutive relationship acquisition section 216, and is structured as explained below.

The definition-attribute dictionary section 202 stores a definition attribute name, parameter names associated with the definition attribute, and information on whether each of the parameter names is a definition attribute or a stress attribute, in association with one another.

For instance, the definition attribute name includes “polyamide”, and “slide bearing”. The parameter relating to “polyamide” includes “polyamide wear coefficient Kpa”, which is a control attribute.

The parameter relating to “slide bearing” includes “guaranteed run time Hr”, “wear allowance δ”, and “wear coefficient K” as the control attributes, and “pressure P applied to bearing” and “bearing slide velocity V” as the stress attributes.

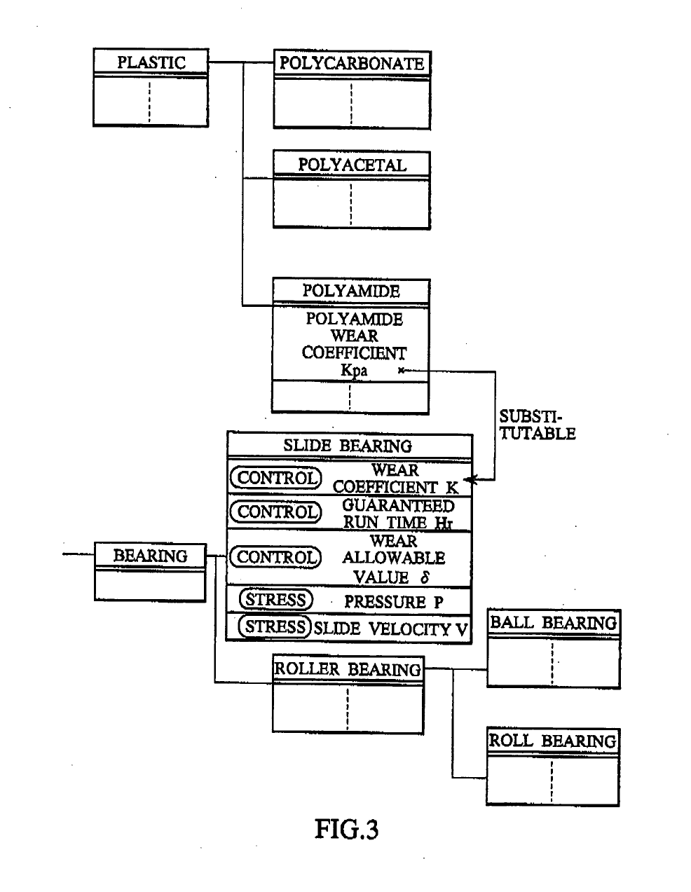

FIG. 3 is an exemplary diagram illustrating the brief structure of the data structure of information stored in the definition-attribute dictionary section 202 and the control-attribute dictionary section 215.

As illustrated in this diagram the information on various definition attributes in the definition-attribute dictionary section 202 is hierarchically stored.

Meanwhile, if the parameter value of any control attribute can be substituted by the parameter value of another control attribute, the control-attribute dictionary section 215 stores the parameter name which is substitutable and the parameter name which can be substituted as the substitutive relationship.

That is, the control-attribute dictionary section 215 stores the substitutive relationship indicating that “polyamide wear coefficient Kpa” can substitute “wear coefficient K” in addition to the above-described parameter names “wear coefficient K”, “polyamide wear coefficient Kpa”, “guaranteed run time Hr”, and “wear allowance δ”.

As illustrated in this diagram those substitutive relationships are organized in the hierarchical structure.

Meanwhile, the strength dictionary section 203 stores a strength name, the parameter name of the control attribute required for calculating the strength name, and the procedure for calculating the strength value using that parameter value.

In this example, the strength dictionary section 203 stores “limited PV value” as the strength name. As the parameter names required for calculating that limited PV value, “guaranteed run time Hr”, “wear allowance δ”, “wear coefficient K” are stored, and an equation of “limited PV value=δ/(Hr·K)” is stored as the procedure for calculating the strength value using those parameter names.

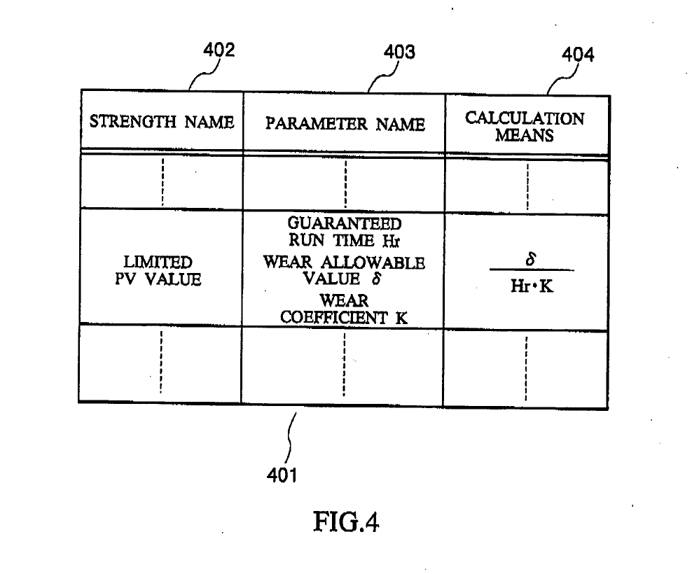

FIG. 4 is an exemplary diagram illustrating the brief structure of the data structure of information stored in the strength dictionary section 203. As illustrated in this diagram, the strength dictionary section 203 accumulates information in a so-called tabular format.

Each row of the table 401 corresponds to each strength, and it is organized and stored such that a row 402 records the strength name, a row 403 stores one or more parameter names of the control attributes, and a row 404 stores the procedure for calculating the strength value.

The stress dictionary section 204 stores the stress name, the parameter name relating to that stress name, and the procedure calculating the stress value using that parameter value.

In this example, the stress dictionary section 204 stores “PV value” as the stress name. As the parameters of the stress attribute required for calculating that PV value, “pressure P applied to bearing” and “berg slide velocity V” are stored, and an equation of “PV value=P·V” is stored as the procedure for calculating the stress value using that stress name and that parameter.

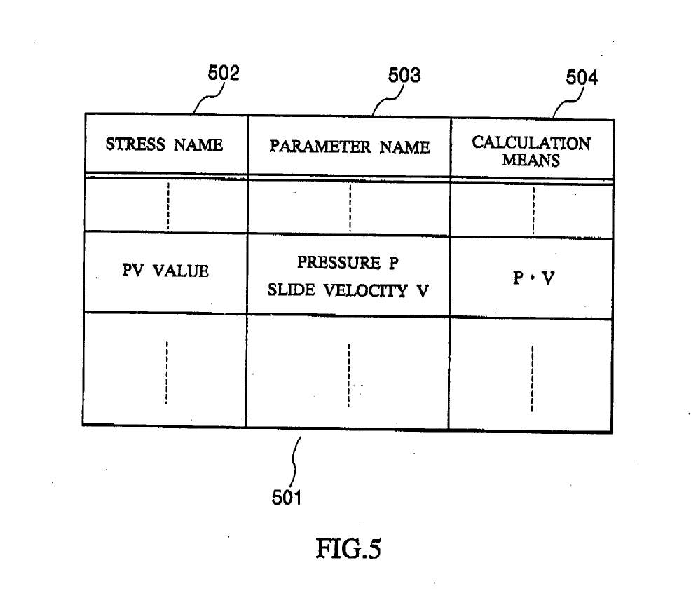

FIG. 5 is an exemplary diagram illustrating the brief structure of the data structure of information stored in the stress dictionary section 204. As illustrated in this diagram, the stress dictionary section 204, like the strength dictionary section 204, accumulates information in a so-called tabular format.

Each row of the table 501 corresponds to each stress, and it is organized and stored such that a row 502 records the stress name, a row 503 stores one or more parameter names of the stress attributes, and a row 504 stores the procedure for calculating the stress value.

The comparison-report dictionary section 205 stores the strength name, the stress name, the procedure for comparison between them, and report information to be reported when the comparison result satisfies a predetermined condition, in association with one another.

In this example, the comparison-report dictionary section 205 stores “PV value” as the stress name, and “limited PV value” as the strength name. Further stored are an equation of “PV value>limited PV value” as the procedure for comparison between them, and report information which is to be reported when the equation is fulfilled.

The report information in the example is a knowledge to the effect that “trouble will occur to bearing”, and a knowledge relating to that knowledge. These knowledges can include various information, such as knowledge information which presents a trouble case happened previously, the UL (Universal Resource Locator) where the knowledge information is saved, a database name, a query expression for the database, and a record number in the database. Those knowledges may further include information for predicting what symptom can happen as the result of the occurrence of the trouble, and information required for predicting the cause for the trouble.

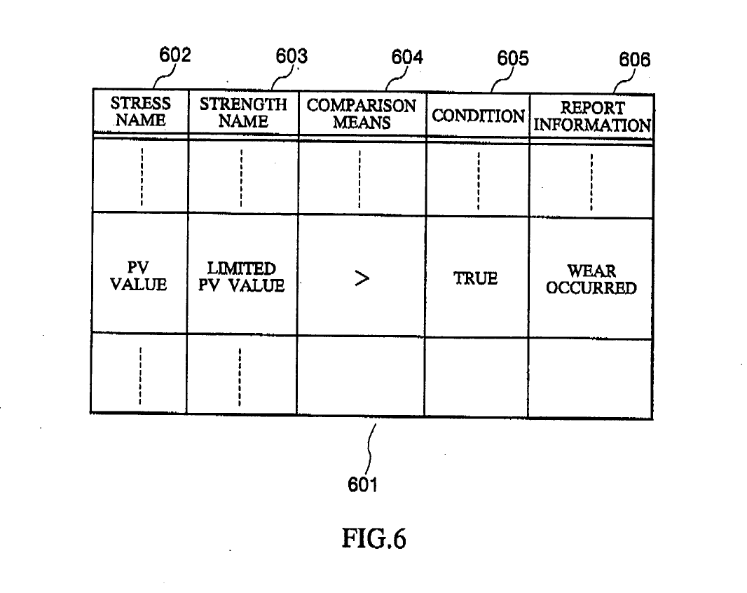

FIG. 6 is an exemplary diagram illustrating the brief structure of the data structure of information stored in the comparison-report dictionary section 205. As illustrated in this diagram, the information stored in the comparison-report dictionary section 295 is also organized in a tabular format.

Each row of the table 601 corresponds to each report information, and it is organized and stored such that a row 602 records the stress name, a row 603 stores the strength name, the row 604 stores the procedure for comparison between them, a row 605 stores the condition that the comparison result should satisfy, and a row 606 stores the report information.

In the diagram, with respect to the stress name “PV value” and the strength name “limited PV value”, “>” as the comparison procedure, and “true” as the condition that the comparison result should satisfy, are stored, but various calculations and conditions such that the comparison procedure is “−(subtraction)”, and the condition that the comparison result should satisfy is “positive”, may be stored.

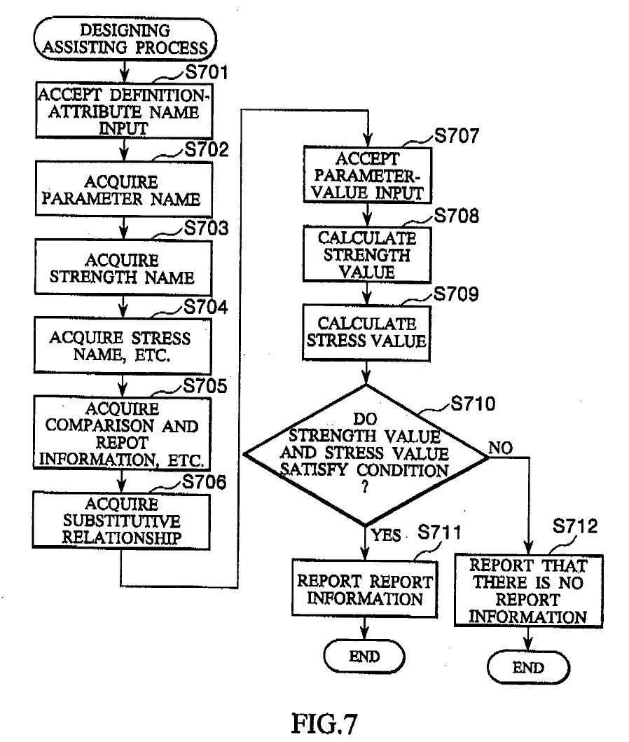

FIG. 7 is a flowchart illustrating the procedures of the designing assisting process which are executed under the circumstance where various pieces of information are stored as described above. An explanation will be given below with reference to the diagram.

First, the input accepting section 206 accepts the input of the definition attribute of the design target (step S701).

Accordingly, information on the design target, designed by a designer with a CAD/CAM system, is accepted, or the information on the design target is directly accepted.

In this example, as the designer designs the “polyamide bearing”, the definition attribute names input here are “polyamide” and “slide bearing”. In general, various definition attribute names other than those are to be input.

The definition-attribute acquisition section 207 acquires the definition attribute names, stored in the definition-attribute dictionary section 202, from the input definition attribute names, the parameter names relating to those definition attributes, and information on whether each of those is the control attribute or the stress attribute (step S702).

At this time, the control-attribute acquisition section 208 acquires the parameter names of the control attributes, acquired by the definition-attribute acquisition section 207, from the control-attribute dictionary section 215 to check that those parameter names are stored in the control-attribute dictionary section 215.

In this example, the definition-attribute dictionary section 202 stores the parameter name of the control attribute as the character string, but a mode where the identification number of the control attribute is stored, may be adopted. In this case, the control-attribute dictionary section is to store the identification number of the control attribute and the character string indicating that parameter name in association with each other, and the control-attribute acquisition section 208 executes a process for obtaining the parameter name of the control attribute from the identification number of the parameter of the control attribute by referring to the control-attribute dictionary section 215.

Accordingly, “polyamide wear coefficient Kpa” (control attribute) is acquired for “polyamide”, and, “guaranteed run time Hr” (control tribute), “wear allowance δ” (control attribute), “wear coefficient K” (control attribute), “pressure P applied to bearing” (stress attribute), and “bearing slide velocity V” (stress attribute) are acquired for “slide bearing”.

The strength acquisition section 209 acquires, from the strength dictionary section 203, the strength name which can be calculated using the parameter names of the acquired control attributes, and the procedure for calculating the strength value (step S703).

Accordingly, the strength name “limited PV value” and information that the strength name can be calculated from “δ/(Hr·K)” are acquired from “guaranteed run time Hr” (control attribute), “wear allowance δ” (control attribute), and “wear coefficient K” (control attribute).

Meanwhile, the stress acquisition section 210 acquires, from the stress dictionary section 204, the stress name which can be calculated using the parameter names of the acquired control attributes, and the procedure for calculating the stress value (step S704).

Accordingly, the stress name “PV value” and information that the strength name can be calculated from “P·V” are acquired from “pressure P applied to bearing” (stress attribute), “bearing slide velocity V” (stress attribute).

When the acquired computable strength name and the acquired computable stress name are stored in the comparison-report dictionary section 205 in association with each other, the report-information acquisition section 211 acquires the stored comparison procedure in association with them, and the report information which is to be reported if the comparison result satisfies the predetermined condition (step S705).

In this example, as the strength name “limited PV value” and the stress name “PV value” are stored in the comparison-report dictionary section 205 in association with each other, “PV value>limited PV value” as the comparison procedure and the report information that “trouble will occur to bearing” are acquired when the comparison result is satisfied.

The substitutive relationship acquisition section 216 acquires, from the parameter names of the acquired control attributes, a pair of the parameter names of the control attribute stored in the control-attribute dictionary section 215 as the substitutive relationship (step S706).

In this example, the information that the parameter “polyamide wear coefficient Kpa” can be substituted by the parameter “wear coefficient K” is acquired.

If the comparison procedure and the report information are acquired by the report-information acquisition section 211, the input accepting section 206 further accepts the inputs of the parameter value of the acquired control attribute and the parameter value of the acquired stress attribute. When the parameter name of the acquired control attribute is the parameter name, which can be substituted, of the acquired substitutive relationship, the input accepting section 206 further accepts the input of the parameter value of the parameter which can be substituted, or, instead, the parameter value of the parameter which can substitute (step S707).

Accordingly, the input accepting section 206 prompts the designer or the CAD/CAM system to input the parameter values of the following parameter names.

“guaranteed run time Hr”

“wear allowance δ”

either one of “wear coefficient K” or “polyamide wear coefficient Kpa”

“pressure P applied to bearing”

“bearing slide velocity V”

The strength calculation section 212 calculates the strength value from the parameter value of the input control attribute by the procedure for calculating the acquired strength value. At this time, when the procedure for calculating the acquired strength value uses the parameter value of the parameter name, which can be substituted, of the acquired substitutive relationship, and, instead of the parameter value of the parameter name, which can be substituted, the parameter value of the substitutable parameter name is accepted by the input accepting section 206, the strength calculation section 212 substitutes the substitutable parameter value of the parameter name for the parameter value of the parameter name, which can be substituted, and calculates the strength value (step S708).

In this example, the strength value “limited PV value” is calculated from the equation “δ/(Hr·k)” when “wear coefficient K” is input, and from the equation “δ/(Hr·k)” when “polyamide wear coefficient kpa” is input.

The stress calculation section 213 calculates the stress value from the parameter value of the input stress attribute by the procedure for calculating the acquired stress value (step S709).

In this example, the stress value as “PV value” is calculated from the equation “P·V”.

The comparison report section 214 compares the calculated strength value and the calculated stress value by the acquired comparison procedure (step S710), and, when the result satisfies the predetermined condition (step S710; Yes), the comparison report section 214 reports the acquired report information (step S711), and terminates the process.

When it is not satisfied (step S710; No), on the other hand, the comparison report section 214 reports that the report information is not found (step S712), and terminates the process.

That is, in this embodiment, the calculated stress value (PV value) and the value (limited PV value) are compared by “PV value>limited PV value”, and, when that equation is satisfied, the report information that “trouble will occur to bearing” is reported.

As illustrated in the embodiment, by accepting the input of the definition attribute and the control attribute of the design target from the user, the strength value and the stress value can be calculated, and the report information can be presented.

In the embodiment, in consideration of the substitutive relationship between some control attribute and another control attribute, even if the value of some control attribute is not input, if the value of the control attribute which is substitutable for that control attribute is input, the strength value can be calculated using that value of the substitutive control attribute, and the input burden on the user can be reduced.

Further, it is possible to cope with a case where the parameter values of the various control attributes can be calculated from the other parameter values.

That is, when the parameter value of some control attribute can be calculated by the calculation procedure using the parameter value of the other control attribute, the control attribute dictionary section 215 further stores the calculation procedure, the parameter name relating to the calculation used by the calculation procedure, and the calculation-result parameter name of the calculation, as the calculation relationship.

For instance, when there are “bearing length L” and “inner diameter D of bearing”, “cross-sectional area S of bearing” can be calculated by the procedure “S=L·D”.

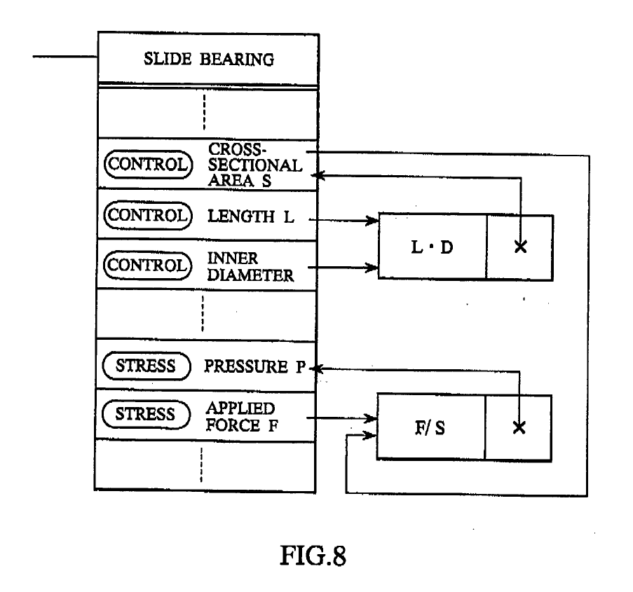

FIG. 8 illustrates the brief structure of a section where the forgoing calculation relationship is stored in the control-attribute dictionary section.

Meanwhile, the substitutive relationship acquisition section 216 acquires, at step S706, the calculation relationship which takes the parameter name of the control attribute acquired from the control-attribute dictionary section 215, as the calculation result parameter, and the parameter name relating to the calculation.

At step S707, when the parameter name of the acquired control attribute is the calculation result parameter of the acquired calculation relationship, the input accepting section 206 further accepts the parameter value of the calculation result parameter, or, instead, the parameter value of the parameter name relating to the calculation.

For instance, when “cross sectional area S of bearing” is the control attribute acquired as the parameter name required for the calculation of the strength value, the input accepting section 206 may accept, by the acquired calculation relationship, either one input of “bearing length L” and “inner diameter D of bearing”, or “cross-sectional area of bearing”.

At step S708, when the parameter value of the calculation result parameter name of the calculation relationship acquired by the procedure for calculating the acquired strength value, and, instead of the parameter value of the calculation result parameter name, the parameter value of the parameter name for the calculation is accepted by the input accepting section 206, the strength calculation section 206 acquires the calculation procedure of the calculation relationship from the control-attribute dictionary section 215, calculates the parameter value by the calculation procedure using the parameter value of the parameter name for the calculation that the input is accepted, and substitute the calculated parameter value for the parameter value of the calculation result parameter name, thereby calculating the strength value.

That is, when “cross-sectional area S of bearing” is input, the value thereof is directly used, and, if “bearing length L” and “inner diameter D of bearing” are input, “D·L” is used instead of “cross-sectional area S of bearing”, and the strength value is calculated.

According to the invention, when the parameter value required for calculating the strength value can be calculated from the parameter value already input by the user, the calculation using the parameter value is automatically carried out, and the strength value is calculated, and, the input burden on the user can be reduced.

In the basic structure, the calculation relationship is stored and used only for the control attribute, but similar calculation relationships can be applied to both the stress attribute and the control attribute. For instance, “pressure P applied to bearing” (stress attribute) can be from “force F applied to bearing” (stress attribute) and “cross-sectional area S of bearing” (control attribute) like “P=F/S”. Therefore, by using those calculation relationships, like the control-attribute-to-control-attribute calculation relationship, the effort of inputting the parameters can be reduced.

In addition, the designing assisting apparatus 201 with the basic structure may be structures as follows.

That is, the definition-attribute dictionary section 202 further stores parent-child relationships between some definition attribute and another definition attribute.

For instance, “bearing” includes “slide bearing” and “roller bearing”, “roller bearing” includes “ball bearing” and “roll bearing”, and those parent-child relationships can be stored as follows.

“bearing” (parent)-“slide bearing” (child)

“bearing” (parent)-“roller bearing” (child)

“roller bearing” (parent)-“ball bearing” (child)

“roller bearing” (parent)-“roll bearing” (child)

Those are an extracted part of the hierarchical structure of the parent-child relationship.

Likewise, regarding “spring”, the following parent-child relationships can be deemed.

“spring” (parent)-“plate spring” (child)

“spring” (parent)-“coil spring” (child)

“coil spring” (parent)-“compression coil spring” (child)

“coil spring” (parent)-“extension coil spring” (child)

“coil spring” (parent)-“torsion coil spring” (child)

As apparent from the above, a so-called is-a relationship can be expressed using the parental relationship. For instance, “slide bearing” is “bearing” (a slide bearing is a bearing). The parent-child relationship is not limited to the expression for the is-a relationship. As will be explained later, the parent-child relationship can be applied to express other relationships.

Meanwhile, when the parent-child relationship where the definition attribute name already acquired by the definition-attribute acquisition section 207 is a child, is stored in the definition-attribute dictionary section 202, the definition-attribute acquisition section 207 further acquires the definition attribute name which is a parent in the parent-child relationship, the parameter name related to that parent definition attribute, and information on whether each of those parent definition attribute and parameter name is the control attribute or the stress attribute.

For instance, unlike the above-described example, when the design target is “roll bearing”, the control attribute and the stress attribute of “roller bearing” and the control attribute and the stress attribute of “bearing” are acquired in addition to the control attribute and the stress attribute of “roll bearing”.

As described above, when the is-a relationship is expressed by the parent-child relationship, the search area is expanded from some definition attribute to the further general definition attribute. In other words, the search area is expanded from “child” to “parent” in this case. Therefore, as will be described later, the relationships other than the is-a relationship can be expressed by the parent-child relationship. It may be deemed that ““parent-child relationship” is a “relationship” which only indicates a base direction as to in which direction the search area is expanded”.

As the acquired control attributes and the stress attributes increase, the types of the strength values and the stress values, which can be calculated using either the control attribute or the stress attribute, dramatically increase. An increase in the report information to be acquired is expected.

According to the basic structure, regarding the definition attribute in the parent-child relationship, the search area is expanded in the direction of the parent, and the report information can be acquired more. Particularly, when the parent-child relationship is structured in such a way that “the parent and the child respectively express “more general object” and “more specific object”, the search area can be expanded in the general direction.

The parent-child relationship can be treated as a more general relationship. That is, the definition-attribute dictionary section 202 may be able to store both the parent-child relationship where some definition attribute is the parent and the other definition attribute is the child, and the parent-child relationship where some definition attribute is the child and the other definition attribute is the parent.

In this case, as some definition attribute and the other definition attribute are the parent and the child with respect to each other, it is natural that those are associated with “equal relationship” and “relationship with some strong relativity”. That is, the usage of the data structure of “parent-child relationship” makes the expression for “equal relationship” and “relationship with some strong relativity”.

That is, in this case, it is not only the is-a relationship that is expressed by the parent-child relationship. The equals-to relationship (equal relationship, equivalent relationship) and the relates-to relationship (relationship with some strong relativity) can also be expressed.

As described above, the parent-child relationship is the relationship which defines the direction of the expanding the search area, and, how to fit the parent-child relationship to two of the definition attributes can be adequately changed according to the type of the design target and the field where the designing assisting apparatus 201 is used. Therefore, only the parent-child relationship where both are mutually the parent and the child may be considered as the relates-to relationship, or the relationship where one of them is the parent and the other one is the child, and the reverse is not satisfied may be added to the relates-to relationship.

By using those expressions, when some definition attribute is acquired, in addition to its control attribute and the stress attribute, as the control attribute and the stress attribute of the definition attribute which is in “equal relationship” and “relationship with some strong relativity” with some definition attribute, are to be acquired, the search area is expanded, and report information can be acquired more.

In the above-described basic structure, when there is a parent-child relationship, the search area is expanded from the child to the parent, but the reverse is possible too.

That is, when the parent-child relationship where the definition attribute name already acquired is the parent is stored in the definition-attribute dictionary section 202, and there are plural definition attribute names which are the children in that parent-child relationship, the definition-attribute acquisition section 207 the definition-attribute acquisition section 207 accepts the input which selects one or more children definition attribute names, and further acquires the selected children definition attribute names, the parameter names relating to the children definition attributes, and information on whether or not each of the children is the control attribute or the stress attribute.

Although “slide bearing” is the design target in the above-described example, let us consider a case where the design target is bearing”. In this case, first, the user is requested to input either “slide bearing” or “roll bearing”. When the reply to the request is “roller bearing”, the user is further requested to input either “ball bearing” or “roll bearing”. When the reply to the request is “roll bearing”, in addition to the control attribute and the stress attribute of “bearing”, the control attribute and the stress attribute of “roller bearing” and the control attribute and the stress attribute of “roll bearing” are also acquired.

As mentioned above, the expansion of the search area to the direction of the child is particularly suitable for a case where the part is the definition attributes of the material and the parts, and the children are the product name, the part-number name, and the figure name which designs the children.

Accordingly, regarding the definition attribute in the parent-child relationship, the user can be adequately prompted to put limitations to prevent the search area from being exploded, while the search area is expanded in the direction of the children to acquire more report information. Particularly, when the parent-child relationship is structured in such a way that “the parent and the children respectively express “more general object” and “more specific objects”, the search area can be expanded in a more specific direction. For instance, the trouble which does not happen to the general “slide bearing” but happens to “slide bearing” of the part-number B made by the company A can be acquired.

The mode can be applied to the case where “equal relationship” and “relationship with some strong relativity” are expressed using the parent-child relationship, making it possible to adequately prompt the user to put limitations to prevent the search area from being exploded while expanding the search area to acquire more report information.

The basic structure takes an exclusive relationship into consideration in addition to the above-described basic structure.

That is, the definition-attribute dictionary 202 further stores the exclusive relationship between some definition attribute name and the other definition attribute name.

For instance, regarding “plastic”, the following exclusive relationships can be deemed.

from the viewpoint of material, “polyamide”, “polycarbonate”, and “polyacetal”

from the viewpoint of heat characteristic, “thermoplastic resin”, and “thermosetting resin”

from the viewpoint of electrical conductivity, “electrical conductivity”, and “non-electrical conductivity”

In a case where the definition attributes are organized and stored in the above-described hierarchical structure, the exclusive relationship can be stored easily.

Meanwhile, the report information stored in the comparison-report dictionary section 205 includes the definition attribute relating to the report information.

The comparison report section 214 reports that report information in the acquired report information which satisfies a predetermined condition and does not include the definition attribute name having the exclusive relationship with the input definition attribute name not stored in the definition-attribute dictionary section 202.

For instance, even if the input definition attribute name is “polyamide” (particularly to the case like the above-described basic structure where the search area is expanded with respect to parent-child and equal relationships and some relativity) the report information not for “polyamide” may be often acquired. Accordingly, when the input definition attribute name is polyamide”, the comparison report section 214 abandons the report information for “polycarbonate” and “polyacetal”, and does not report them to the user.

The input accepting section 206 may further accepts the input of the exclusive definition attribute name to be excluded from the design target, and allow the user to specify the unnecessary definition attribute name beforehand, and the comparison report section 214 may report that report information in the acquired report information which satisfies the predetermined condition and does not include the input exclusive definition attribute name.

The comparison report section 214 may report the report information in the acquired report information which satisfies the predetermined condition and includes at least one definition attribute name being the input definition attribute name.

That is, in the above-described example, only when the report information explicitly includes “polyamide”, it is to be reported.

Accordingly, the acquired report information can be selected to exclude the unnecessary report information as much as possible, and to present the necessary information to the user.

### EMBODIMENT OF THE INVENTION

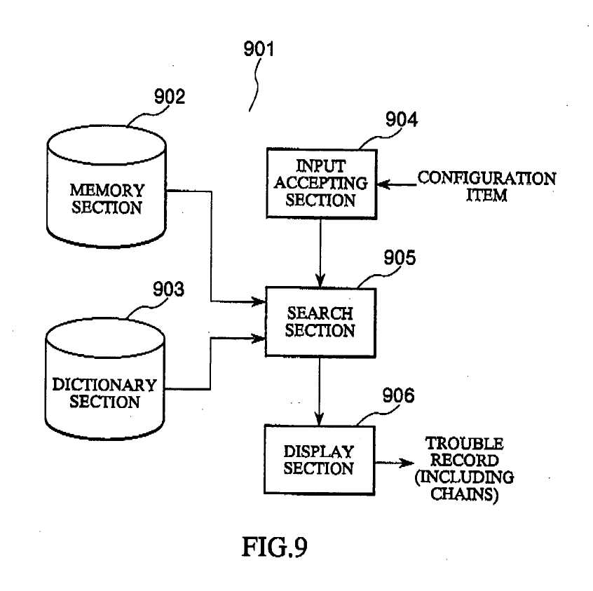

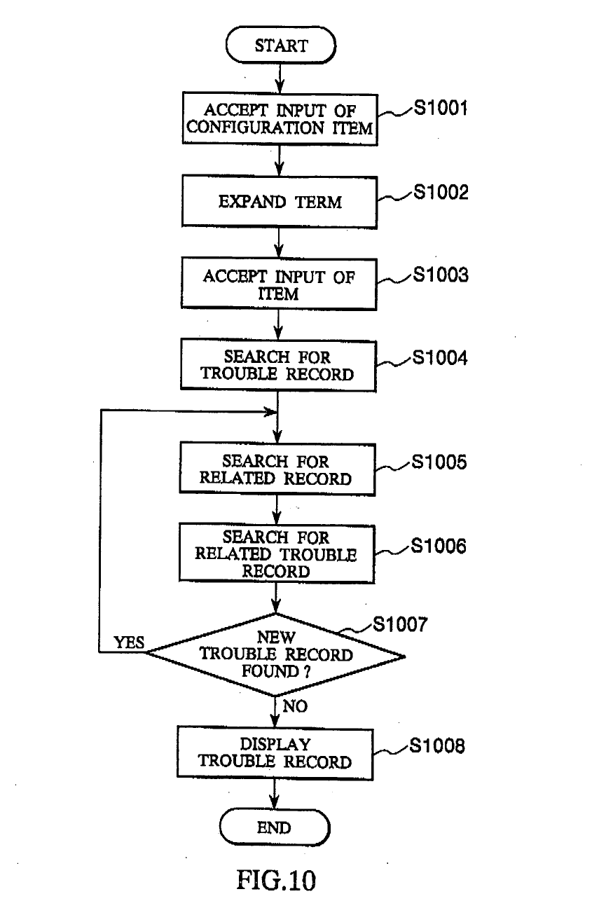

The invention is suitable to be adapted to a designing assisting apparatus having the above-described basic structure and to add new functions hereto. The following will discuss one of such embodiments. FIG. 9 is an explanatory diagram illustrating the brief structure of a designing assisting apparatus according to the embodiment FIG. 10 is a flowchart illustrating the control flow of a process which is executed by the designing assisting apparatus. A description will be given below referring to those diagrams.

A designing assisting apparatus 901 comprises a memory section 902, a dictionary section 903, an input accepting section 904, a search section 905, and a display section 906.

First, the memory section 902 stores trouble records which associate one definition attribute name or more, zero control attribute name or more, zero stress attribute name or more, and zero strength name or more of a design target with one trouble mode name or more.

The memory section 902 can be considered as a database so structured as to be able to acquire information stored in the definition-attribute dictionary section 202, the strength dictionary section 203, the stress dictionary section 204, the comparison-report dictionary section 205 and the control-attribute dictionary section 215 in a report information unit (which corresponds to a single trouble record). According to the embodiment, therefore, by providing a view to arrange data in a report information unit in a database having various hierarchical structures, each report information in the view is let to be a trouble record. The identification number of report information is a trouble mode. Depending on the structure of the database, the trouble record may be structured in a simple table-like form.

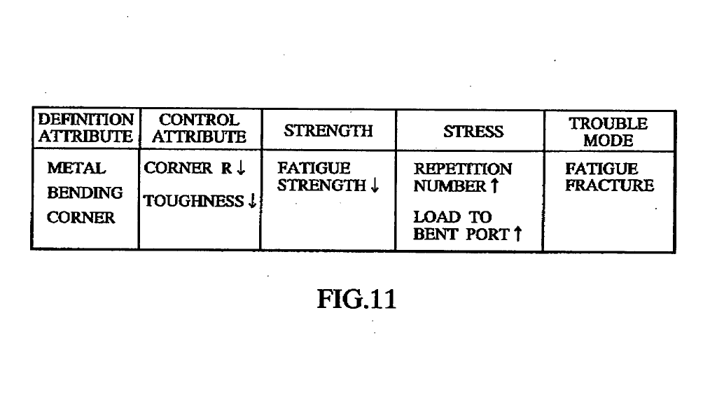

FIG. 11 is an explanatory diagram illustrating one appearance of such a trouble record. A description will be given below referring to this diagram.

The following information is designated in a trouble record.

“metal”, “bending” and “corner” as definition attribute names.

“corner R ↓” and “toughness ↓” as control attribute names.

“fatigue strength ↓” as a strength name.

“repetition number ↑” and “load to bent portion ↑” as stress attribute names.

“fatigue fracture” as a trouble mode name.

“↑” and “↓” that appear at the ends of those names are called “variation mode”, and names excluding those may be thought as their names.

In the embodiment, “fatigue fracture” is only one trouble mode name, but a plurality of trouble mode names may be stored in a single related record.

Meanwhile, the dictionary section 903 stores related records which associate a trouble mode name as a cause name with a definition attribute name, a control attribute name, a stress attribute name, a strength name or a trouble mode name as a result name.

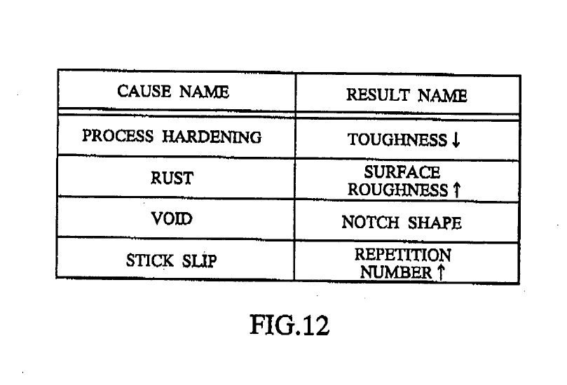

FIG. 12 is an explanatory diagram illustrating the appearance of information to be stored in the dictionary section 903. Information to be stored in the dictionary section 903 is given by a table.

A trouble mode name which is stored in some trouble record is designated as a cause name in one row in the table. A definition attribute name, a control attribute name, a stress attribute name, a strength name or a trouble mode name is stored as a result name. At this time, information like “↑” or “↓” may be given to a name like a stress attribute name.

Each row of the table is called a related record, which means that when the trouble mode of the cause name occurs, the definition attribute, the control attribute, the stress attribute or the strength of the result name is influenced or another trouble mode occurs. That is, the chain “some trouble becomes the cause of another trouble” is expressed by a related record.

“↑” or “↓” means that the influence on the stress attribute or the like acts in the direction of increasing or decreasing the parameter. For example, the it row of the table is a related record which shows that when “process hardening” occurs, “toughness” drops.

While the diagram shows an example where only one trouble mode name is designated as the cause name, plural trouble mode names may be given. This case corresponds to a case where at the time trouble mode names designated by the cause name occurs simultaneously, the definition attribute, the control attribute, the stress attribute ad the strength of the result name are influenced or another trouble mode name occurs. In this case, particularly, plural trouble mode names designated are called “simultaneous cause names”, and the result name corresponding thereto is called “simultaneous result name”.

In the embodiment, the knowledge about a design target is acquired by using such a memory section 902 and dictionary section 903. The processes that are carried out in the embodiment will be executed in the embodiment will be discussed in order.

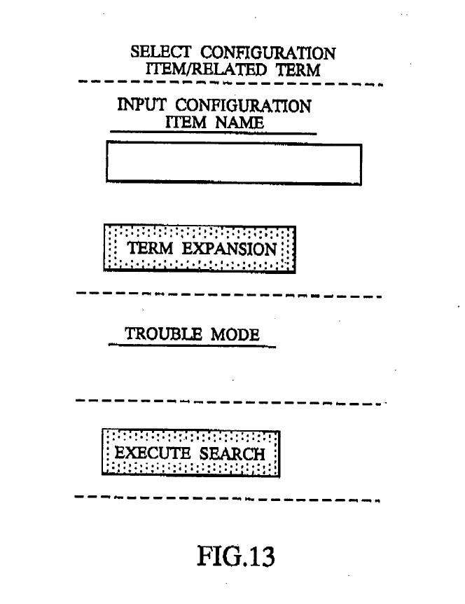

First, the input accepting section 904 prompts an entry of a configuration item as a design target (step S1001). FIG. 13 is an explanatory diagram illustrating a form for accepting an input of the name of a configuration item. The user inputs the name of a configuration item in a configuration item name field of the form, and clicks a term expansion button. In the following, let us consider a case where “spring plate” is input as a configuration item.

then, the designing assisting apparatus 901 expands the definition attribute name, the control attribute name, and the stress attribute name (hereinafter called “terms” as needed) from the input configuration item (step S1002).

In the basic structure, an example is given of a case where the input accepting section 206 prompted the input of a definition attribute name and the user input “polyamide” and “slide bearing” at the time of designing “polyamide bearing”, and various names, such as “polyamide wear coefficient Kpa” (control attribute), “guaranteed run time Hr” (control attribute), “wear allowance δ” (control attribute), “wear coefficient K” (control attribute), “pressure P applied to bearing” (stress attribute), “bearing slide velocity V” (stress attribute), “PV value” (stress attribute), and “limited PV value” (strength), are expanded from those definition attributes, and further, various names relating to them are expanded according to the hierarchical structure, but a similar scheme is adopted in this embodiment.

That is, a database which stores a configuration item and a definition attribute name in association with each other is provided separately. Alternatively, it is stored in the memory section 902 or the like, a definition attribute name is acquired from an input configuration item, and, as in the above-described basic structure, a definition attribute name is expanded from this definition attribute name.

Further, as in the above-described basic structure, a control attribute name and a stress attribute name are expanded from the expanded definition attribute name.

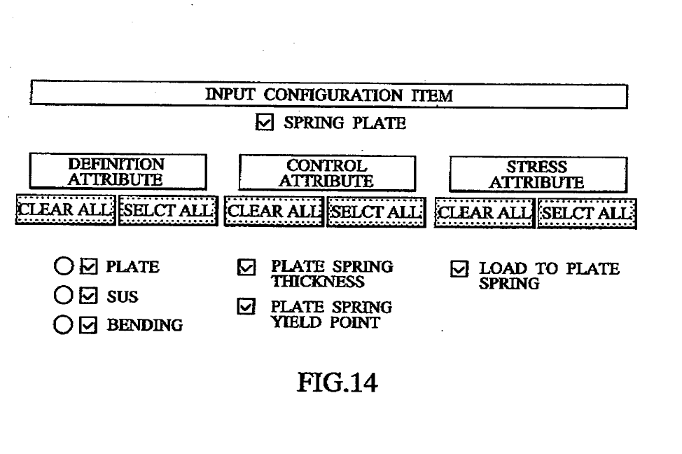

Then, the input accepting section 904 accepts one or more inputs of the definition attribute name, the control attribute name or the stress attribute name (step S1003). FIG. 14 is an explanatory diagram illustrating a form showing terms, obtained by term expansion, and arranged for each definition attribute name, control attribute name or stress attribute name.

The form shows “spring plate” as words of fixation of the configuration item. Further, “plate”, “SUS” and “bending” are shown as the definition attribute, “load to plate spring” is shown as the stress attribute, and “plate spring thickness” and “plate spring yield point” are shown as the control attributes.

The user selects the desired definition attribute name, control attribute name or stress attribute name from those, and checks on the check box to the left of the displayed name, then returns to the form shown in FIG. 13 and clicks the search execute button.

Then, the search section 905 first searches the trouble records stored in the memory section 902 for a trouble record which includes the definition attribute name, the control attribute name or the stress attribute name whose input has been accepted (seep S1004).

Then, for each of the trouble records searched so far, the related records stored in the dictionary section 903 are searched for those related records which include, as a cause name, the trouble mode names included in the trouble records searched so far (step S1005).

Further, the trouble records stored in the memory section 902 are searched for a trouble record which includes the definition attribute name, the control attribute name, the stress attribute name, the strength name or the trouble mode name included as a result name in the related records searched so far (step S1006).

Then, it is determined whether or not a new trouble record is searched (step S1007), and when a new trouble record is found (step S1007; Yes), the flow returns to step S1005. When a new one is not found (step S1007; No), the flow proceeds to step S1008.

FIG; 15 shows a trouble record which is obtained when “plate”, “SUS” and “bending” are input at step S1003. Every trouble mode obtained in this embodiment is a trouble record which is searched at step S1004 upon entry of the definition attribute.

Then, the display section 906 displays the searched trouble record (step S1008).

At this time, when a related record including “the trouble mode name of the displayed trouble record as a cause name” and “the definition attribute name, the control attribute name, the stress attribute name, the strength name or the trouble mode name of another displayed trouble record as a result name” is stored in the dictionary section 903, a figure which connects the displayed trouble record and the displayed another trouble record is further displayed.

Particularly, the display section 906 further displays the cause name in association with that trouble record which includes that cause name, further displays the result name in association with that trouble record which includes that result name, and displays “a reference figure (including a figure of an arrow) from the cause name to the result name” as “a figure connecting the displayed trouble record and the displayed another trouble record”.

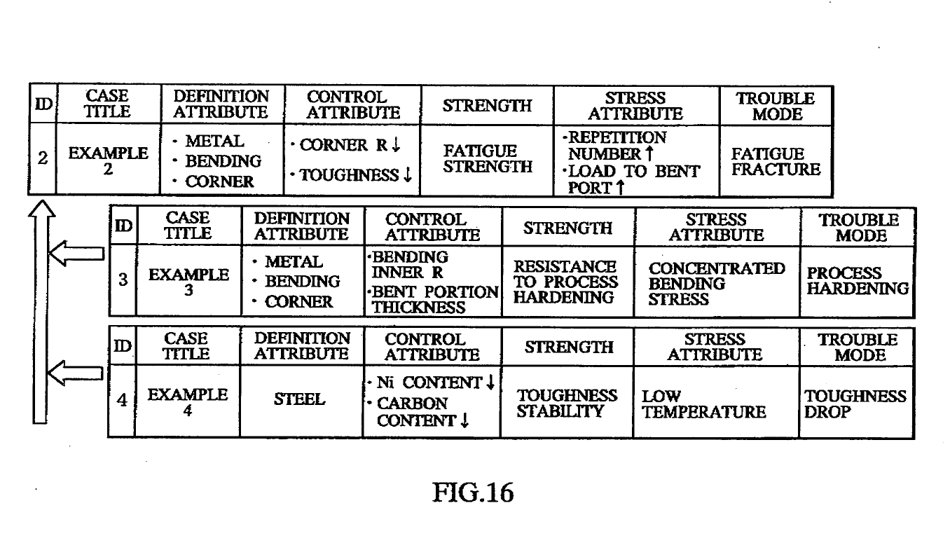

FIG. 16 is an explanatory diagram illustrating the appearance of a trouble record shown in a form this way.

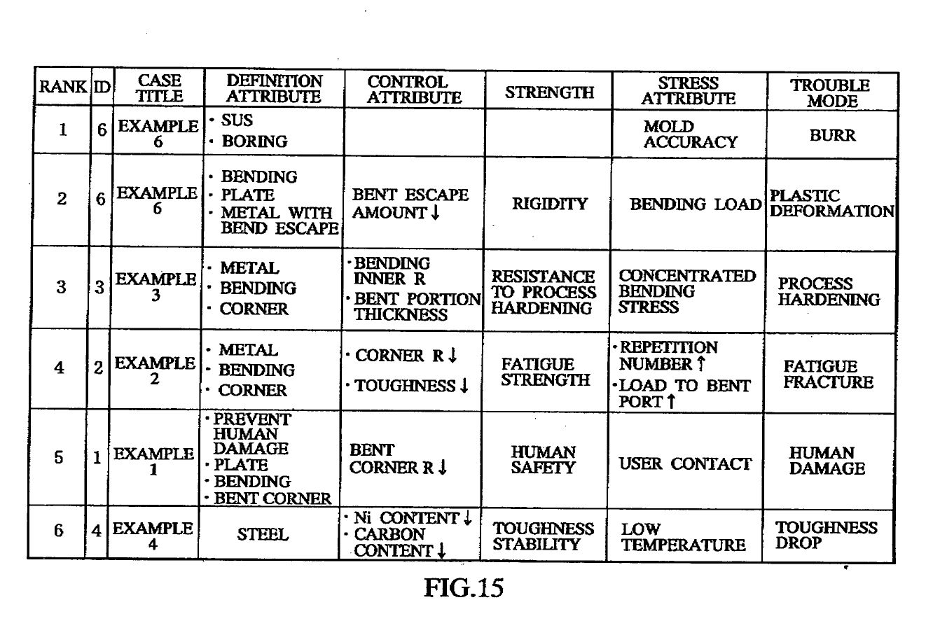

This diagram shows only those mutually related portions extracted. The form shows three trouble records. They are all what is shown in FIG. 15.

In the embodiment, arrows are drawn from the trouble record “process hardening” and the trouble record “toughness drop” to the trouble record “fatigue fracture”. Further, “process hardening” and “toughness ↓”, and “toughness drop” and “toughness ↓” are highlighted by underlines and changing the font displaying scheme.

This is because the related record

cause “process hardening” (trouble mode)
->result “toughness ↓” (control attribute)
   is stored in the dictionary section 903, and the trouble record “fatigue fracture” includes the control attribute “toughness ↓”.

From the diagram, the designer can know that the trouble “fatigue fracture” may occur from the trouble “process hardening”, and the trouble “process hardening” may occur from the trouble “toughness drop”. That is, he can know the chain of troubles.

A list of independent records which do not have a trouble causal relationship with one another is shown, together with the display example in FIG. 16, as per the display method in FIG. 15. That is, FIG. 16 extracts a part of the example of the display result by the display section 906.

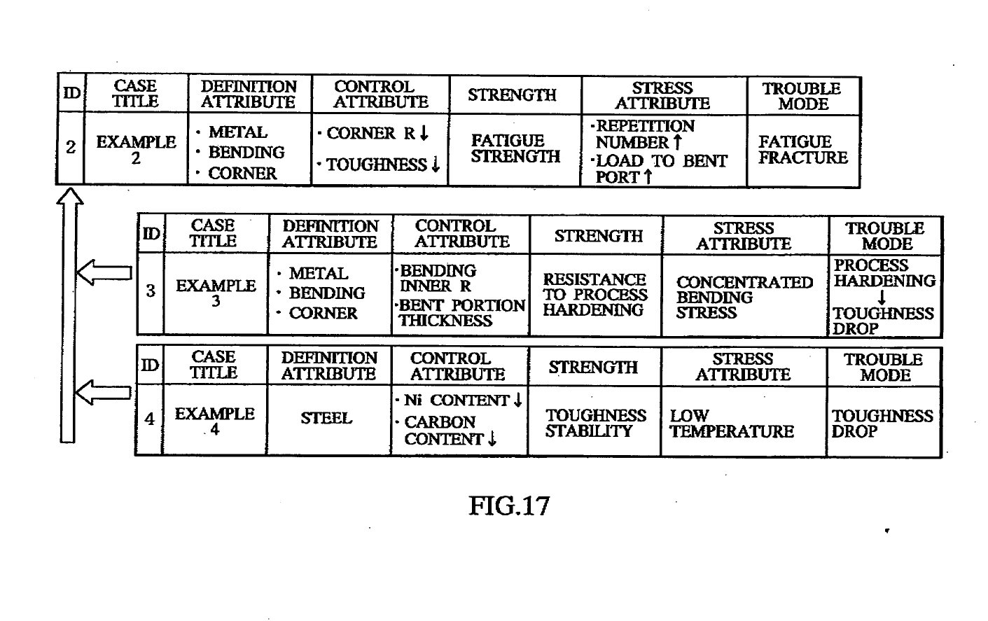

In addition, those relationships may be denoted by different arrows as in FIG. 17. In the diagram, for example, an arrow is shown from the trouble mode name “process hardening” to “toughness drop” in the trouble mode field. This “toughness drop” is another trouble mode name. That is, in the diagram, the result name “toughness drop” (equivalent to a term in another trouble record) is shown in the vicinity of the cause name “process hardening”, and an arrow is shown from the former to the latter.

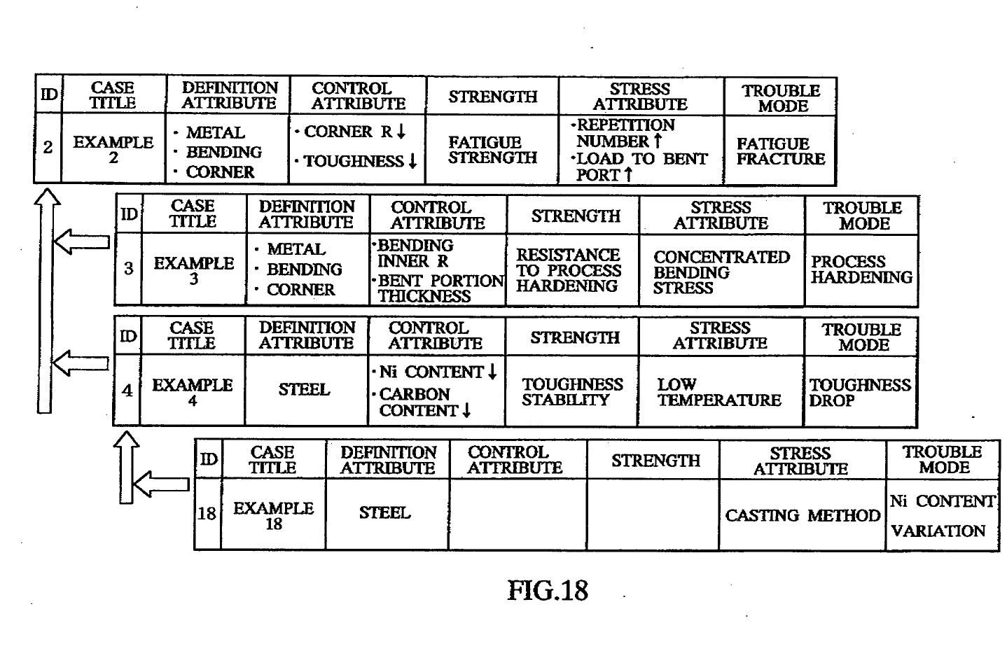

Although only one level of trouble chain is shown in the example shown in FIG. 16, if plural levels of chains occur, those are also shown by the connection with arrows according to the process at step S1008. FIG. 18 shows a display example in a case where such trouble chains are found.

Although an arrow is drawn from a trouble record to a trouble record in those display examples, an arrow may be shown from the cause name in one trouble record to the cause name of another trouble record in addition thereto or instead. Accordingly, the designer can know detailed information on trouble chains.

When simultaneous cause names and a simultaneous result name associate a plurality of trouble records with one another, i.e., when the condition (AND condition)

(i) a trouble record including the simultaneous result name is included in the search result, and

(ii) for each of the simultaneous cause names, all trouble records having that name as the trouble mode name are included in the search result,

is fulfilled, it means that some kind of influence occurs on the definition attribute, the control attribute, the strength, and the stress attribute when one trouble mode and another trouble mode happen simultaneously.

In such a case, therefore, the arrow from the trouble record equivalent to the cause to the trouble record equivalent to the result is highlighted.

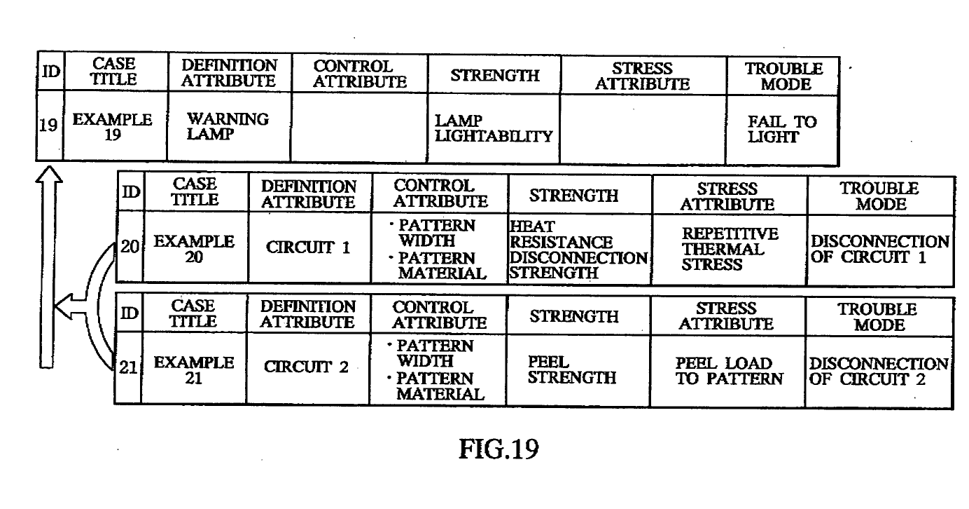

FIG. 19 shows a display example in a case where such an AND condition is fulfilled. In the display example, to show the AND condition, the shape of the arrow is changed to be highlighted. In addition, various techniques can be adapted as highlighting schemes, such as changing the color and showing various kinds of information in characters in the vicinity of the arrow.

As the relevancy of the trouble modes is shown this way, this process is terminated.

At step S1004, the following filtering may be carried out. That is, when one or more definition attribute names are input at step S1003, only that trouble record which includes at least one definition attribute name input at step S1003 is retrieved from the searched trouble records.

In addition, filtering may be performed to eliminate a related record including a definition attribute exclusively related to the definition attribute name (or a definition attribute name expanded therefrom) as done in the basic structure.

This can prevent the number of trouble records to be found in the chain of trouble records from becoming very large.

### INDUSTRIAL APPLICABILITY

As described above, it is possible to provide a designing assisting apparatus and a designing assisting method which are suitable for finding, at the designing stage, the possibility of causing a trouble in a design target, and a program for allowing a computer to realize them.

The present application claims the priority of Japanese Patent Application No. 2003-61677, and incorporates all the contents of the basic application.

1. A designing assisting apparatus comprising a memory section, a dictionary section, an input accepting section, a search section and a display section, characterized in that
said memory section stores trouble records which associate one definition attribute name or more, zero control attribute name or more, zero stress attribute name or more, and zero strength name or more of a design target with one trouble mode name or more,
said dictionary section stores related records which associate a trouble mode name as a cause name with a definition attribute name, a control attribute name, a stress attribute name, a strength name or a trouble mode name as a result name,
said input accepting section accepts one or more inputs of the definition attribute name, the control attribute name or the stress attribute name, said search section
(a) searches said stored trouble records for a trouble record which includes said definition attribute name, control attribute name or stress attribute name whose input has been accepted,
(b) searches said stored related records for a related record which includes the trouble mode name included in said searched trouble record, as a cause name,
(c) searches said stored trouble records for a trouble record which includes said definition attribute name, control attribute name, stress attribute name, strength name or trouble mode name included as a result name in said searched related record, and (d) repeats said (b) and (c) until no new trouble record is searched, and said display section
(p) displays said searched trouble record, and
(q) further displays a figure connecting said displayed trouble record and said displayed another trouble record when a related record including a trouble mode name in said displayed trouble record as a cause name, and a definition attribute name, a control attribute name, a stress attribute name, a strength name or a trouble mode -name as a result name in said displayed another trouble record is stored in said dictionary section.

2. The designing assisting apparatus according to claim 1, characterized in that said display section further displays said cause name with that trouble record which includes said cause name, further displays said result name with that trouble record which includes said result name, and displays “a reference figure (including a figure of an arrow) from said cause name to said result name” as “a figure connecting said displayed trouble record and said displayed another trouble record”.

3. The designing assisting apparatus according to claim 2, characterized in that said dictionary section stores a simultaneous related record which associates a plurality of trouble mode names as simultaneous cause names with a definition attribute name, a control attribute name, a stress attribute name or a trouble mode name as a simultaneous result name, and
said display section displays said reference figure highlighted when, in the “reference figure from said cause name to said result name” “said stored plurality of trouble mode names as the simultaneous cause names of ‘the simultaneous related record to be stored in said memory section with said result name as the simultaneous result name’ are all displayed by said display section.

4. The designing assisting apparatus according to claim 1, characterized in that when an input of one definition attribute name or more is accepted by said input accepting section, said search section
(a) searches said stored trouble records for a trouble record which includes said definition attribute name, control attribute name or stress attribute name whose input has been accepted and which includes at least one of the definition attribute names whose inputs have been accepted, in place of said (a).

5. A designing assisting method using a memory section which stores trouble records associating one definition attribute name or more, zero control attribute name or more, zero stress attribute name or more, and zero strength name or more- of a design target with one trouble mode name or more, and a dictionary section which stores related records associating a trouble mode name as a cause name with a definition attribute name, a control attribute name, a stress attribute name, a strength name or a trouble mode name as a result name, and comprising an input accepting step, a search step and a display step, characterized in that
at said input accepting step, one or more inputs of the definition attribute name, the control attribute name or the stress attribute name are accepted,
at said search section,
(a) said stored trouble records are searched for a trouble record which includes said definition attribute name, control attribute name or stress attribute name whose input has been accepted,
(b) said stored related records are searched for a related record which includes the trouble mode name included in said searched trouble record, as a cause name,
(c) said stored trouble records are searched for a trouble record which includes said definition attribute name, control attribute name, stress attribute name, strength name or trouble mode name included as a result name in said searched related record, and
(d) said (b) and (c) are repeated until no new trouble record is searched, and
at said display section,
(p) said searched trouble record is displayed, and
(q) a figure connecting said displayed trouble record and said displayed another trouble record is further displayed when a related record including a trouble mode name in said displayed trouble record as a cause name, and a definition attribute name, a control attribute name, a stress attribute name, a strength name or a trouble mode name as a result name in said displayed another trouble record is stored in said dictionary section.

6. A program for allowing a computer to function as a memory section, a dictionary section, an input accepting section, a search section and a display section, characterized in that
said memory section stores trouble records which associate one definition attribute name or more, zero control attribute name or more, zero stress attribute name or more, and zero strength name or more of a design target with one trouble mode name or more,
said dictionary section stores related records which associate a trouble mode name as a cause name with a definition attribute name, a control attribute name, a stress attribute name, a strength name or a trouble mode name as a result name,
said input accepting section accepts one or more inputs of the definition attribute name, the control attribute name or the stress attribute name,
said search section
(a) searches said stored trouble records for a trouble record which includes said definition attribute name, control attribute name or stress attribute name whose input has been accepted,
(b) searches said stored related records for a related record which includes the trouble mode name included in said searched trouble record, as a cause name,
(c) searches said stored trouble records for a trouble record which includes said definition attribute name, control attribute name, stress attribute name, strength name or trouble mode name included as a result name in said searched related record, and
(d) repeats said (b) and (c) until no new trouble record is searched, and
said display section
(p) displays said searched trouble record, and
(q) further displays a figure connecting said displayed trouble record and said displayed another trouble record when a related record including a trouble mode name in said displayed trouble record as a cause name, and a definition attribute name, a control attribute name, a stress attribute name, a strength name or a trouble mode name as a result name in said displayed another trouble record is stored in said dictionary section.
